(19) United States
(12) Patent Application Publication
(10) Pub. No.: US 2023/0177910 A1
(43) Pub. Date: Jun. 8, 2023

(54) INFORMATION PROCESSING APPARATUS, INFORMATION PROCESSING METHOD, BEVERAGE CONTAINER, BEVERAGE SERVER, AND ELECTRONIC DEVICE

(71) Applicant: SONY GROUP CORPORATION, TOKYO (JP)

(72) Inventors: MASAHIRO SUEYOSHI, TOKYO (JP); HIROSHI OKADA, TOKYO (JP); HISANORI ARAI, TOKYO (JP)

(21) Appl. No.: 17/906,887

(22) PCT Filed: Mar. 16, 2021
(86) PCT No.: PCT/JP2021/010491

§ 371 Date: Sep. 21, 2022

(30) Foreign Application Priority Data
Mar. 30, 2020 (JP) 2020-060385

(51) Int. Cl. G07F 13/10; G06Q 20/40

(52) U.S. Cl. CPC G07F 13/10; G06Q 20/405

(57) ABSTRACT

The present technology pertains to an information processing apparatus, an information processing method, a beverage container, a beverage server, and an electronic device that make it possible to more simply provide a beverage using a beverage container. Provided is an information processing apparatus equipped with a processing unit that generates purchase information including a purchase condition pertaining to purchase of a beverage and a container identifier identifying a beverage container, and, on the basis of the generated purchase information, performs processing for providing the beverage using the beverage container. For example, the present technology can be applied to a beverage platform that enables an end user to purchase a beverage using a beverage container such as a reusable cup or a reusable bottle.

### TECHNICAL FIELD

The present technology pertains to an information processing apparatus, an information processing method, a beverage container, a beverage server, and an electronic device, and in particular pertains to an information processing apparatus, an information processing method, a beverage container, a beverage server, and an electronic device that make it possible to more simply provide a beverage using a beverage container.

### BACKGROUND ART

Various beverage vending machines having generally-called reusable-cup functionality have been proposed.

For example, PTL 1 discloses a beverage vending machine in which individual identification information stored by an IC tag provided on a cup is stored in association with beverage information, the identification information is read out from the IC tag, and, when selling a beverage to the cup, control is performed to allow the beverage to be sold on the basis of the identification information read out from the IC tag provided on the cup and the beverage information stored in association therewith.

### CITATION LIST

### Patent Literature

[PTL1]
Japanese Patent Laid-Open No. 2006-127138

### SUMMARY

### Technical Problem

In recent years, services with various methods such as a subscription method have been proposed, and the level of satisfaction end users have with services is improving. However, there have been requests for simpler provision of beverages in relation to services that use beverage containers such as a reusable cup.

The present technology is made in the light of such a situation, and makes it possible to more simply provide a beverage using a beverage container.

### Solution to Problem

An information processing apparatus according to one aspect of the present technology is equipped with a processing unit that generates purchase information including a purchase condition pertaining to purchase of a beverage and a container identifier identifying a beverage container, and, on the basis of the generated purchase information, performs processing for providing the beverage using the beverage container.

An information processing method according to one aspect of the present technology is a method in which an information processing apparatus generates purchase information including a condition pertaining to purchase of a beverage and an identifier identifying a beverage container, and, on the basis of the generated purchase information, performs processing for providing the beverage using the beverage container.

In an information processing apparatus and an information processing method according to one aspect of the present technology, purchase information, which includes a condition pertaining to a purchase of a beverage and an identifier identifying a beverage container, is generated and, on the basis of the generated purchase information, processing for providing the beverage using the beverage container is performed.

A beverage container according to one aspect of the present technology has an IC chip that, in response to a request from an information processing apparatus that generates purchase information including a purchase condition pertaining to purchase of a beverage and a container identifier identifying a beverage container, and, on the basis of the generated purchase information, performs processing for providing the beverage using the beverage container, performs short-range wireless communication with a reader/writer provided in a beverage server that discharges the beverage to the beverage container, whereby the purchase information is written or the purchase information, having been recorded, is read out.

In a beverage container according to one aspect of the present technology, in response to a request from an information processing apparatus that generates purchase information including a purchase condition pertaining to purchase of a beverage and a container identifier identifying a beverage container, and, on the basis of the generated purchase information, an IC chip is used to perform processing for providing the beverage using the beverage container and perform short-range wireless communication with a reader/writer provided in a beverage server that discharges the beverage to the beverage container, whereby the purchase information is written or the purchase information, having been recorded, is read out.

A beverage server according to one aspect of the present technology has a reader/writer that, in response to a request from an information processing apparatus that generates purchase information including a purchase condition pertaining to purchase of a beverage and a container identifier identifying a beverage container, and, on the basis of the generated purchase information, performs processing for providing the beverage using the beverage container, performs short-range wireless communication with an IC chip attached to the beverage container placed on a container placement platform, whereby the purchase information is written or the purchase information, having been recorded, is read out.

In a beverage server according to one aspect of the present technology, in response to a request from an information processing apparatus that generates purchase information including a purchase condition pertaining to purchase of a beverage and a container identifier identifying a beverage container, and, on the basis of the generated purchase information, performs processing for providing the beverage using the beverage container, a reader/writer is used to perform short-range wireless communication with an IC chip attached to the beverage container placed on a container placement platform, whereby the purchase information is written or the purchase information, having been recorded, is read out.

An electronic device according to one aspect of the present technology includes a presentation unit that presents presentation information pertaining to a beverage, the presentation information being notified from an information processing apparatus that generates purchase information including a purchase condition pertaining to purchase of the beverage and a container identifier identifying a beverage container, and, on the basis of the generated purchase information, performs processing for providing the beverage using the beverage container, an acceptance unit that accepts the purchase condition designated by an end user in response to the presented presentation information, and a readout unit that reads out the container identifier that has been recorded to the beverage container, in which the purchase information is generated on the basis of the purchase condition designated by the end user and the container identifier read out from the beverage container.

In an electronic device according to one aspect of the present technology, presentation information pertaining to a beverage is presented, the presentation information being notified from an information processing apparatus that generates purchase information including a purchase condition pertaining to purchase of the beverage and a container identifier identifying a beverage container, and, on the basis of the generated purchase information, performs processing for providing the beverage using the beverage container, the purchase condition designated by an end user in response to the presented presentation information is accepted, and the container identifier that has been recorded to the beverage container is read out. In addition, the purchase information is generated on the basis of the purchase condition designated by the end user and the container identifier read out from the beverage container.

An information processing apparatus or electronic device according to one aspect of the present technology may be an independent apparatus or may be an internal block configuring one apparatus.

### BRIEF DESCRIPTION OF DRAWINGS

FIG. 1 is a view that illustrates an example of a configuration of a beverage platform to which the present technology is applied.

FIG. 2 is a view that illustrates an example of an overall configuration of the beverage platform to which the present technology is applied.

FIG. 3 is a view that illustrates an example of data types managed by a database in the beverage platform.

FIG. 4 is a view that illustrates a scope of entities, centered on the beverage platform.

FIG. 5 is a view that illustrates an example of a data structure used by the beverage platform.

FIG. 6 is a view that illustrates an example of a hardware configuration of a PF server that configures the beverage platform.

FIG. 7 is a view that illustrates an example of a functional configuration of the PF server in FIG. 6.

FIG. 8 is a view that illustrates an example of a hardware configuration of an information device.

FIG. 9 is a view that illustrates an example of a functional configuration of the information device in FIG. 8.

FIG. 10 is a view that illustrates an example of operation in each scenario for the beverage platform.

FIG. 11 is a sequence diagram that illustrates a flow of processing in a case of performing an initial setting on a business side.

FIG. 12 is a sequence diagram that illustrates a flow of processing in a case of performing an initial setting on an end user side.

FIG. 13 is a sequence diagram that illustrates a flow of processing in a case of setting a purchase condition on an end user side.

FIG. 14 is a sequence diagram that illustrates a flow of processing in a case of performing an actual purchase of a beverage on an end user side.

FIG. 15 is a sequence diagram that illustrates a flow of processing in a case of obtaining initial registration information regarding a business side.

FIG. 16 is a sequence diagram that illustrates a flow of processing in a case of obtaining purchase history information and notifying advice, on a business side.

### DESCRIPTION OF EMBODIMENTS

### 1. Embodiment of Present Technology

Various services that provide a beverage using a beverage container such as a reusable cup or a reusable bottle have been proposed. At present, in order for an end user to purchase a beverage they like using a beverage container such as a reusable cup, the end user needs to designate the beverage and explicitly designate settlement means each time.

In addition, at present, because it is not possible to limit a purchase location for a beverage, provide an expiration date by which purchasing it possible, or set a maximum number of purchases that corresponds to a product scheduled to be purchased, it has not been possible to propose subscription-based usage that considers ease for end users or requests by end users.

On the end user side, there is also the problem that it takes time and effort to manage a history relating to beverages such as what they drunk or how much. Specifically, it is not possible to perform management such as managing a history for a beverage for which a target amount to drink in one day has been decided, or providing a daily upper limit for alcoholic beverages and limiting from a beverage server the number of times that an alcoholic beverage can be drunk.

Furthermore, because a history of purchases by an end user is also not accumulated at present, it is not possible to use such a history to provide advice. In other words, it has not been possible to manage, as log information, a beverage purchase history for an end user who uses a beverage container such as a reusable cup, or for a beverage manufacturer or a beverage server manufacturer to use such log information to directly advise the end user on health aspects (healthcare).

Note that PET bottles or cans are at present the primary containers used when a beverage is purchased at a vending machine, etc., and there have not been sufficient efforts to reduce the load on the global environment by end users using beverage containers such as reusable cups or reusable bottles.

Accordingly, in order to solve the problems described above, the present technology proposes a beverage platform that enables an end user to purchase a beverage using a beverage container such as a reusable cup or a reusable bottle. Description is given below regarding embodiments of the present technology, with reference to the drawings.

### (System Configuration)

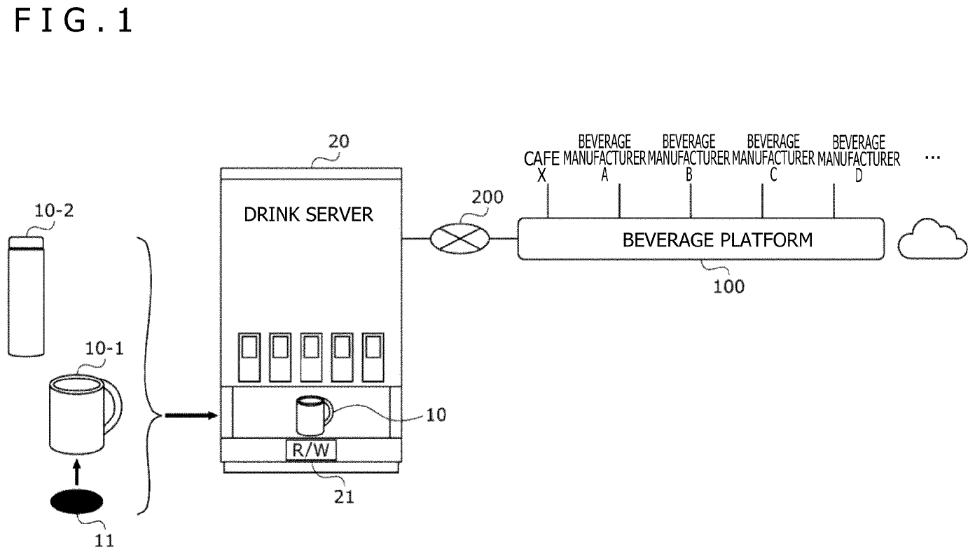

FIG. 1 illustrates an example of a configuration of a beverage platform to which the present technology is applied.

A beverage platform 100 is a platform for providing a service (hereinafter also referred to as a beverage subscription service) that enables an end user to use a beverage container 10 such as a reusable cup 10-1 or a reusable bottle 10-2 to purchase a beverage according to details of a contract. The beverage platform 100 is used by a beverage manufacturer, a beverage server manufacturer, a proxy settlement business, end users, etc.

A beverage manufacturer is an entity that manufactures and sells beverages (drinks). A beverage server manufacturer is an entity that manufactures and sells a beverage server 20 that provides beverages to end users. A beverage manufacturer provides beverages to the beverage server manufacturer.

An end user is an entity that uses their own beverage container 10 such as a reusable cup 10-1 or reusable bottle 10-2 to purchase a beverage from the beverage server 20. The beverage container 10 which is the reusable cup 10-1, for example, is used as a container for beverages, but an IC chip 11 equipped with a short-range wireless communication function is mounted to a predetermined position such as the bottom surface of the beverage container 10. Details are described below, but the IC chip 11 is used in, for example, a case of writing subscription information or performing authentication.

Subscription information is information for providing a service corresponding to a subscription method and includes information such as a purchase condition, a beverage container ID, a number of actual purchases, and a purchase datetime. The subscription method is a method in which a fixed fee is paid to thereby, for example, be guaranteed to be able to receive a service for certain time period, with the fee being paid according to the time period during which the service is used. For example, if a fixed fee is paid in units of every month or every year, during this time period an end user can use the beverage container 10 to drink all the beverage they want.

A purchase condition is a condition pertaining to purchase of a beverage and includes information such as a purchase location, an expiration date, a product to be purchased, a maximum number of purchases, and a settlement type.

A beverage container ID is a container identifier that identifies the beverage container 10 and is uniquely numbered for the beverage container 10. For example, in a case of using a reusable cup 10-1 as the beverage container 10, the beverage container ID becomes a reusable cup ID.

In FIG. 1, the IC chip 11, which is a coin type IC token, for example, is mounted to the bottom surface of the beverage container 10, which is the reusable cup 10-1 for example. For example, when the beverage container 10 is placed on a container placement platform of a beverage server 20 installed at an eatery such as a restaurant or a cafe, short-range wireless communication is performed between a reader/writer 21 and the IC chip 11, in which subscription information recorded to the IC chip 11 is processed.

In addition, the beverage server 20 discharges from a discharge unit an internally-held beverage to the beverage container 10 placed on the container placement platform, whereby the beverage is poured into the container in the beverage container 10. After discharge of the beverage has completed, the beverage container 10 is extracted from the container placement platform in the beverage server 20.

The beverage server 20 is connected to the beverage platform 100 via a network 200. The network 200 is configured by including a communication network such as the internet, an intranet, or a mobile telephone network, and enables interconnection between devices using a communication protocol such as TCP/IP (Transmission Control Protocol/Internet Protocol).

According to a beverage subscription service, when a beverage is provided using a beverage container 10 such as the reusable cup 10-1, various processing pertaining to an end user who has subscribed to the service is executed on the beverage platform 100. For example, processing for performing member management for end users, authentication of a beverage container 10 used by an end user, settlement performed for an end user, accumulation or distribution of log information pertaining to an end user, provision of advice pertaining to the health of an end user, etc. is performed.

On the beverage platform 100, a beverage server 20, various devices, etc. are provided for each beverage manufacturer or cafe that provides beverages, and provision of a beverage using the beverage container 10 can be performed for an end user. In addition, the beverage platform 100 performs management (business operation) of a beverage server 20 installed at each location.

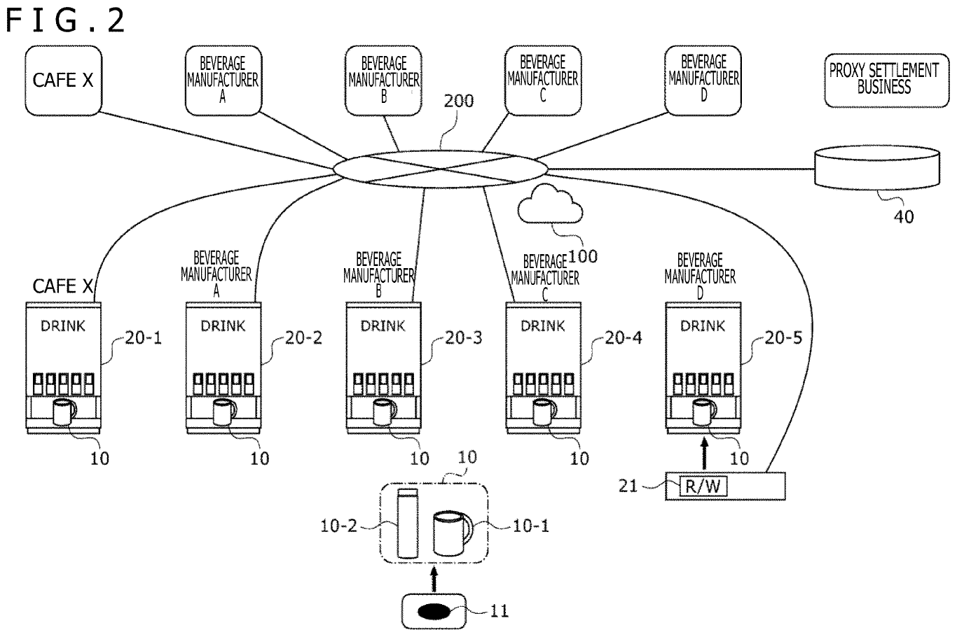

For example, as illustrated in FIG. 2, there is envisioned a case in which a beverage server 20-1 belonging to a cafe X, a beverage server 20-2 belonging to a beverage manufacturer A, a beverage server 20-3 belonging to a beverage manufacturer B, a beverage server 20-4 belonging to a beverage manufacturer C, and a beverage server 20-5 belonging to a beverage manufacturer D are installed at respective locations, and are operating on the beverage platform 100.

Note that, in the example in FIG. 2, a case where a reader/writer 21 is provided for the beverage server 20-5 is illustrated, but a reader/writer 21 is similarly provided for the beverage servers 20-1 through 20-4.

In this case, an end user uses an information device such as a smartphone to register in advance as a member of a beverage subscription service, to thereby be able to receive the provision of a beverage using the beverage container 10 at any of the beverage servers 20-1 through 20-5 that correspond to contract details for this service. When the end user receives provision of a beverage, subscription information recorded in the IC chip 11 on the beverage container 10 placed on the container placement platform is processed, as appropriate, via the reader/writer 21 in a beverage server 20.

At this time, it is possible to record in the IC chip 11 on the beverage container 10, as subscription information, information such as a purchase location which is a vending machine, an eatery, etc., a beverage type which is coffee, black tea, etc., or a number of actual purchases or a purchase datetime which indicate a number of times a beverage is actually purchased or a datetime.

Accordingly, it is possible to use an information device such as a PC (Personal Computer) or a smartphone, the information device being mounted with short-range wireless communication functionality, to read out the subscription information from the IC chip 11 and present information such as how much of what beverage the end user has drunk. Note that these items of information can also be presented online via the network 200, which is the internet, for example, using the beverage platform 100.

It is possible to make a request to an external proxy settlement business for settlement pertaining to the beverage subscription service. In other words, in a case where a request for settlement processing is made from the beverage platform 100, a proxy settlement server 40 performs settlement processing that corresponds to the settlement type, which is electronic money, credit card, etc.

For example, an end user registers a settlement type such as electronic money or credit card when registering as a member of the beverage subscription service to thereby be able to easily resolve payment without going through a complex procedure, even in a case of receiving provision of a desired beverage at one of the beverage servers 20-1 through 20-5 that correspond to the contract details for this service.

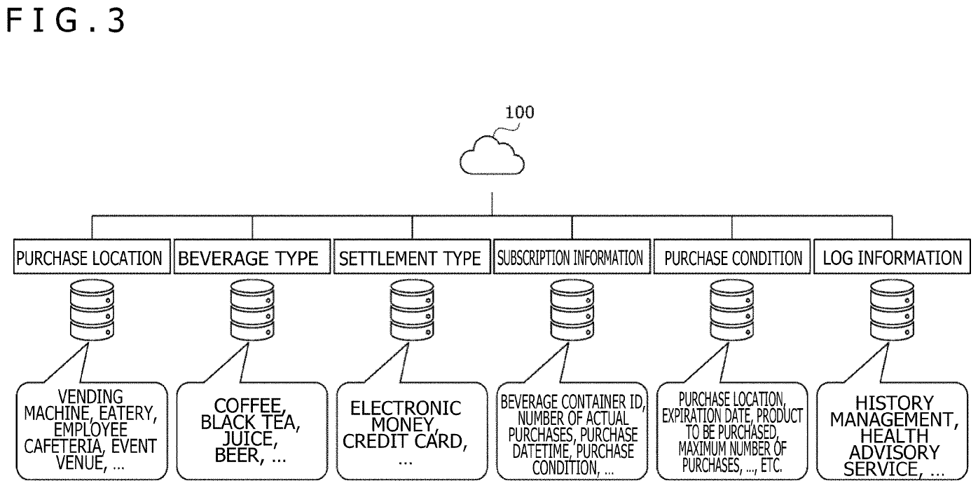

FIG. 3 illustrates an example of data types managed by a database in the beverage platform 100.

These data types include purchase location, beverage type, settlement type, subscription information, purchase condition, and log information.

For the purchase location, it is possible to designate a location such as a vending machine, an eatery (includes a restaurant or a cafe), an employee cafeteria, or an event venue as a location at which a beverage is purchased. For the beverage type, it is possible to designate a beverage such as coffee, black tea, juice, or beer as the type of the beverage. For the settlement type it is possible to designate a type such as electronic money or credit card as the settlement method for a purchased beverage.

The subscription information is configured from information such as beverage container ID, the number of actual purchases, purchase datetime, and purchase condition. Each end user possesses their own beverage container 10, and the beverage container ID is a container identifier that identifies the beverage container 10 possessed by each end user. The number of actual purchases and the purchase datetime represent the number of times an end user actually purchased a beverage using their own beverage container 10, and the datetime at which purchases have been made. The purchase condition is a condition pertaining to purchase of a beverage, and is designated in accordance with, for example, an instruction from an end user.

The purchase condition is configured from information for use of the beverage subscription service, such as purchase location, expiration date, product to be purchased, and maximum number of purchases. The purchase location designates a location at which it is possible to purchase a beverage using the service. The expiration date designates a time period during which it is possible to use the service. The product to be purchased designates a product that can be purchased with the service. The maximum number of purchases designates a number of times a beverage can be purchased using the service.

The log information is configured from information regarding history management, a health advisory service, etc. Regarding history management, information pertaining to beverage purchase history by an end user is managed. The health advisory service includes information for generating an advice message on health aspects (healthcare) on the basis of the beverage purchase history.

### (Entity)

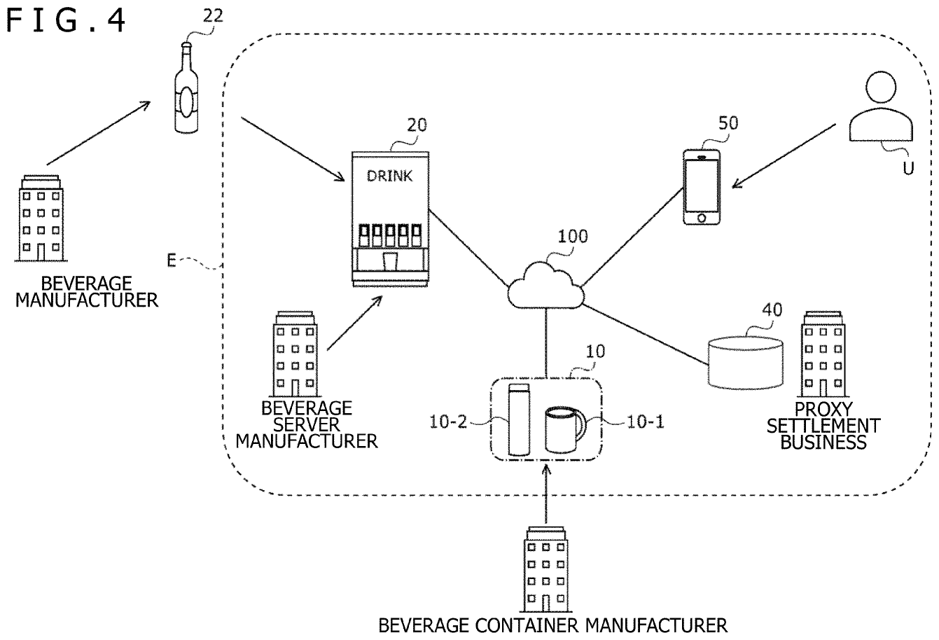

FIG. 4 illustrates a scope of entities centered on the beverage platform 100 to which the present technology is applied. The scope of these entities is represented by a broken-line frame E in the drawing.

In FIG. 4, a beverage server 20 provided by a beverage server manufacturer is installed at various locations, and various types of beverages 22 are provided from a beverage manufacturer and held inside each beverage server 20. Each beverage server 20 is connected to the beverage platform 100, and can provide a desired beverage to end users who are subscribed to the beverage subscription service.

An end user U operates an information device 50 such as a smartphone to connect to the beverage platform 100 to thereby subscribe to the beverage subscription service in advance. In addition, the end user U possesses a beverage container 10 which is provided by a beverage container manufacturer. Subscription information is recorded to the IC chip 11 on the beverage container 10 by the beverage platform 100.

When purchasing a desired beverage, the end user U can receive provision of the desired beverage using their own beverage container 10 by their own beverage container 10 being mounted on the container placement platform of a beverage server 20 and the subscription information recorded to the IC chip 11 being read out by the reader/writer 21 and processed. At this time, configuration is such that the proxy settlement server 40, which is provided by a proxy settlement business, performs settlement processing in response to a request from the beverage platform 100.

### (Data Structure)

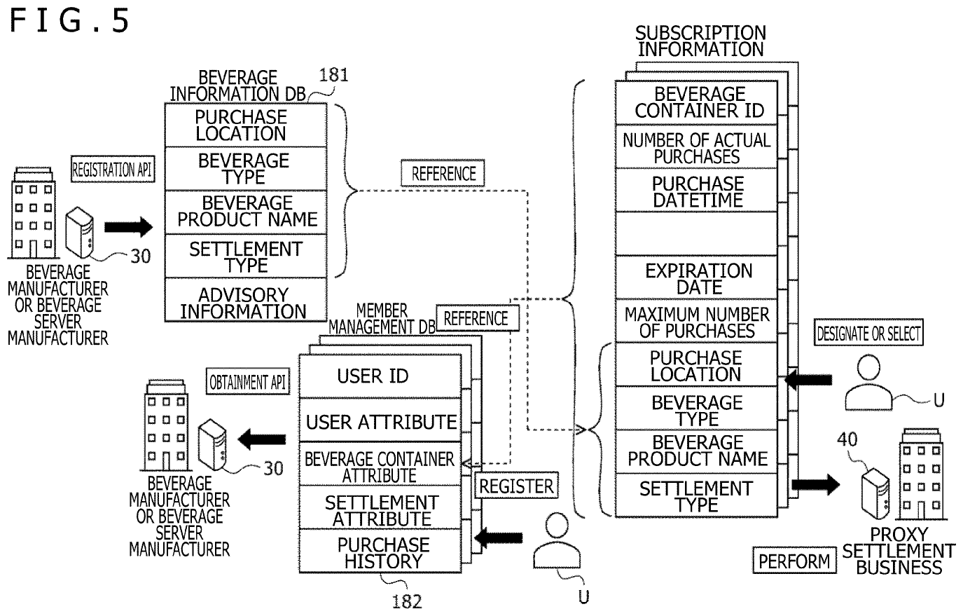

FIG. 5 illustrates an example of a data structure used by the beverage platform 100.

The beverage platform 100 manages databases such as a beverage information DB 181 and a member management DB 182.

A registration API (Application Programming Interface) is executed by a manufacturer server 30, which is provided by a beverage manufacturer or a beverage server manufacturer, and information such as a purchase location, a beverage type, a beverage product name, a settlement type, and advisory information is registered as initial settings in the beverage information DB 181.

When subscribing to the beverage subscription service, the end user U operates the information device 50, which is a smartphone, for example, to register a user attribute such as age or gender and a settlement attribute such as electronic money or a credit card to the member management DB 182 as initial settings.

When end users U subscribe to the service, the beverage platform 100 assigns a user ID for each end user U and uses the member management DB 182 to manage the user ID together with information such as user attributes. Note that, from among information managed by the member management DB 182, a beverage container attribute is associated with information (such as a beverage container ID) pertaining to a beverage container 10 included in the subscription information. In addition, when an end user U has actually purchased a beverage, information pertaining to the purchases is accumulated as history in the purchase history.

The beverage platform 100 presents information registered in the beverage information DB 181 to the information device 50 belonging to an end user U who has subscribed to the beverage subscription service. As a result, the end user U confirms the information presented to the information device 50, selects a purchase location, a beverage type, a beverage product name, a settlement type, etc. as a purchase condition, and designates an expiration date, a maximum number of purchases, etc.

The beverage platform 100 generates subscription information which includes the purchase condition designated or selected by the end user U, the beverage container ID that identifies the beverage container 10, and the number of actual purchases for and purchase datetime at which the end user U actually purchases a beverage, and records the subscription information in the IC chip 11 on the beverage container 10.

The manufacturer server 30 executes an obtainment API, and obtains information stored in the member management DB 182. For example, on the basis of purchase history information obtained from the member management DB 182 and advisory information managed in the beverage information DB 181, the manufacturer server 30 generates an advice message pertaining to good-deal information or points to note on a health aspect and notifies the advice message to the information device 50. As a result, the end user U can confirm the advice message which corresponds to their own beverage purchases.

Note that, in FIG. 5, in response to a request from the beverage platform 100, the proxy settlement server 40 provided by the proxy settlement business performs settlement processing that corresponds to the settlement type included in the subscription information.

(Configuration of PF server)

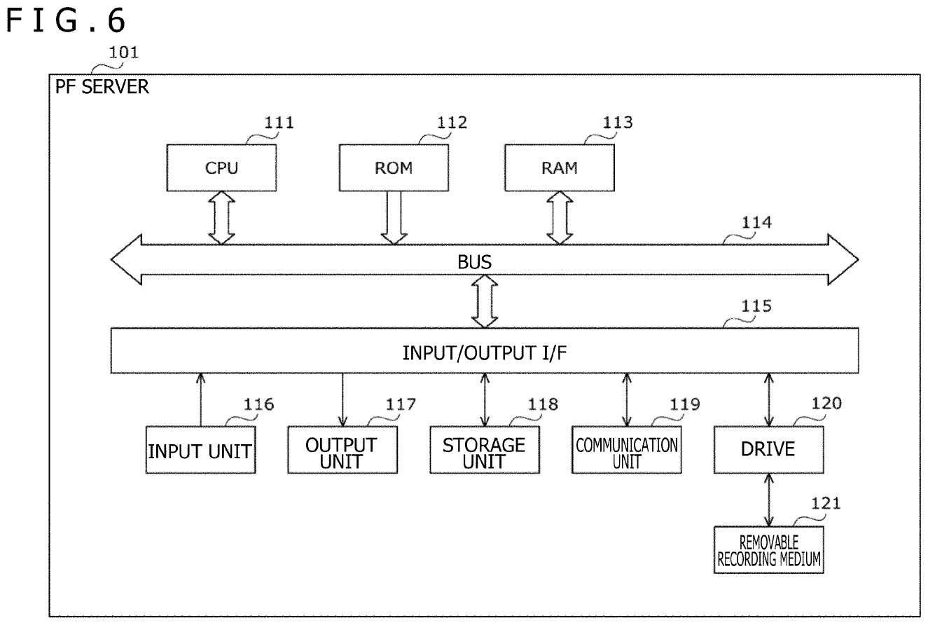

FIG. 6 illustrates an example of a hardware configuration of a PF server 101 that configures the beverage platform 100.

In the PF server 101, a CPU (Central Processing Unit) 111, a ROM (Read-Only Memory) 112, and a RAM (Random-Access Memory) 113 are mutually connected by a bus 114. The CPU 111 executes a program recorded in the ROM 112 or a storage unit 118 to thereby control operation by each unit in the PF server 101. Various types of data are recorded, as appropriate, in the RAM 113.

An input/output I/F 115 is also connected to the bus 114. An input unit 116, an output unit 117, the storage unit 118, a communication unit 119, and a drive 120 are connected to the input/output I/F 115.

The input unit 116 is configured from a microphone, a keyboard, a mouse, etc. The output unit 117 is configured from a speaker, a display, etc. The storage unit 118 is configured from an HDD (Hard Disk Drive), a semiconductor memory, etc. The communication unit 119 is configured as a communication module that supports wireless communication such as a wireless LAN (Local Area Network) or cellular-method communication, or wired communication such as Ethernet (registered trademark).

The drive 120 drives a removable recording medium 121, which is a magnetic disk, an optical disk, a magneto-optical disk, a semiconductor memory, etc.

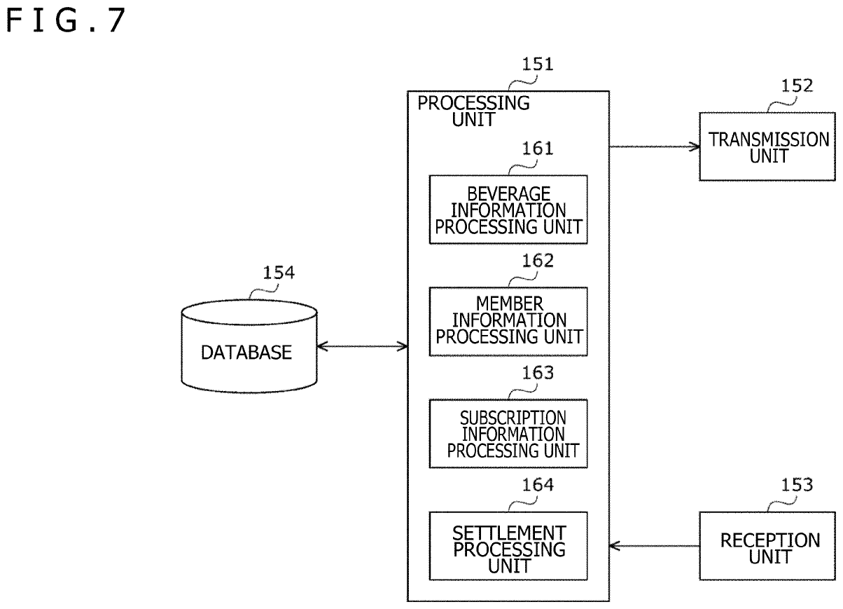

FIG. 7 illustrates an example of a functional configuration of the PF server 101 in FIG. 6. In FIG. 7, each function of a processing unit 151 is realized by the CPU 111 in FIG. 6 executing various types of programs.

A transmission unit 152 and a reception unit 153 are configured as portions of the functionality held by the communication unit 119 in FIG. 6. The transmission unit 152 transmits various items of information supplied from the processing unit 151 to another device via the network 200. The reception unit 153 receives various items of information transmitted from another device via the network 200, and supplies the various items of information to the processing unit 151.

A database 154 is recorded in the storage unit 118 in FIG. 6. For example, the database 154 has databases such as the beverage information DB 181 or the member management DB 182.

The processing unit 151 has a beverage information processing unit 161, a member information processing unit 162, a subscription information processing unit 163, and a settlement processing unit 164.

The beverage information processing unit 161 performs processing pertaining to beverage information managed by the beverage information DB 181.

Specifically, in a case where the reception unit 153 has received beverage information transmitted from the manufacturer server 30, the beverage information processing unit 161 registers the received beverage information in the beverage information DB 181. In addition, in a case where an end user operates the information device 50 to set a purchase condition, the beverage information processing unit 161 supplies beverage information read out from the beverage information DB 181 to the transmission unit 152, and has the beverage information be transmitted to the information device 50 via the network 200.

The member information processing unit 162 performs processing pertaining to information such as member information or purchase history information, which are managed by the member management DB 182.

Specifically, in a case where member information transmitted from the information device 50 in response to an operation by an end user is received by the reception unit 153, the member information processing unit 162 registers the received member information in the member management DB 182. In addition, in a case where member information or purchase history information is requested from the manufacturer server 30, the member information processing unit 162 reads out the member information or the purchase history information from the member management DB 182, supplies the member information or the purchase history information to the transmission unit 152, and has the member information or the purchase history information be transmitted to the manufacturer server 30 via the network 200.

The subscription information processing unit 163 performs processing pertaining to subscription information.

Specifically, in a case where an end user has operated the information device 50 to set a purchase condition, the subscription information processing unit 163 generates subscription information on the basis of the purchase condition and the beverage container ID which are received from the information device 50. The subscription information processing unit 163 supplies the generated subscription information to the transmission unit 152 to thereby transmit the generated subscription information to the information device 50, and has the generated subscription information be written to the IC chip 11 on the beverage container 10.

In addition, in a case where an end user actually purchases a beverage, the subscription information processing unit 163, at a time of having received subscription information read out from the IC chip 11 on the beverage container 10 by the beverage server 20, authenticates the received subscription information. The subscription information processing unit 163 updates the subscription information according to an authentication result, a settlement result, etc., supplies the updated subscription information to the transmission unit 152 to thereby transmit the updated subscription information to the beverage server 20, and has the updated subscription information be written to the IC chip 11 on the beverage container 10.

The settlement processing unit 164 performs processing pertaining to settlement that corresponds to a settlement type such as electronic money or credit card.

Specifically, in a case where the settlement processing unit 164 receives a settlement processing request from the beverage server 20, the settlement processing unit 164 supplies this request to the transmission unit 152, and has this request be transmitted to the proxy settlement server 40 via the network 200. In a case where the settlement processing unit 164 has received a settlement result from the proxy settlement server 40, the settlement processing unit 164 supplies this settlement result to the subscription information processing unit 163.

Note that it may be that the functionality of the processing unit 151 in FIG. 7 is realized by operation by one PF server 101, of course, or may be realized by a plurality of PF servers 101 operating in collaboration.

### (Configuration of Information Device)

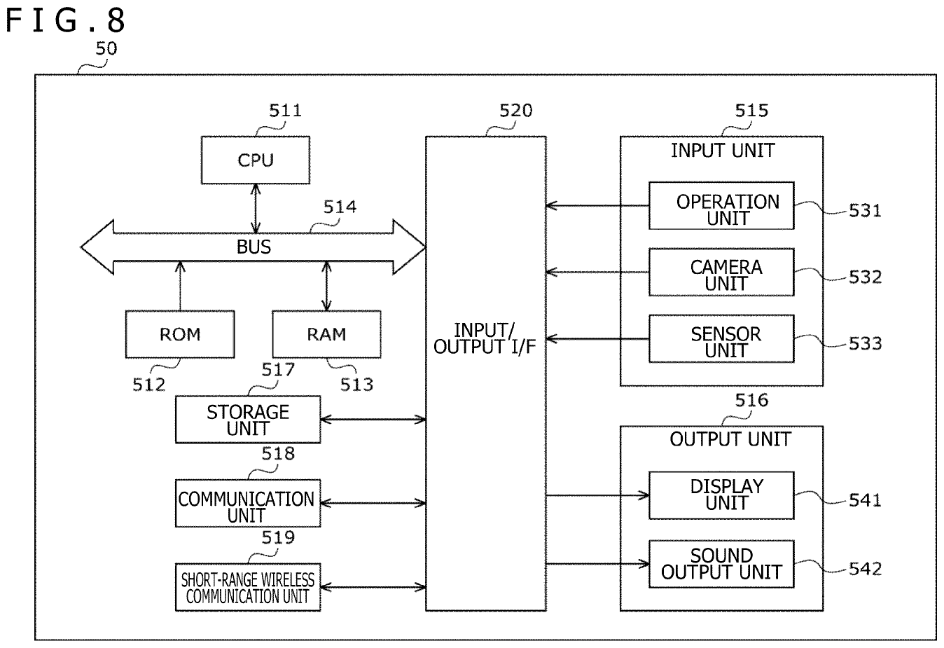

FIG. 8 illustrates an example of a hardware configuration of the information device 50.

In the information device 50, a CPU 511, a ROM 512, and a RAM 513 are mutually connected by a bus 514. The CPU 511 executes a program recorded in the ROM 512 or a storage unit 517 to thereby control operation by each unit in the information device 50. Various types of data are recorded, as appropriate, in the RAM 512.

An input/output I/F 520 is also connected to the bus 514. An input unit 515, an output unit 516, the storage unit 517, a communication unit 518, and a short-range wireless communication unit 519 are connected to the input/output I/F 520.

The input unit 515, via the input/output I/F 520, supplies various types of input data to each unit, including the CPU 511. For example, the input unit 515 has an operation unit 531 configured from a physical button, a touch panel, etc., a camera unit 532 configured from an image sensor, a signal processing unit, etc., and a sensor unit 533 that performs sensing of space information, time information, etc.

The output unit 516 outputs various items of information according to control from the CPU 511 via the input/output I/F 520. For example, the output unit 516 has a display unit 541 configured from a panel unit, a signal processing unit, etc., and a sound output unit 542 configured from a speaker, a headphone connected to an output terminal, etc.

The storage unit 517 records various items of data or programs, according to control from the CPU 511. The storage unit 517 is configured as an auxiliary storage apparatus such as a semiconductor memory.

The communication unit 518 communicates with another device via the network 200, according to control from the CPU 511. The communication unit 518 is configured as a communication module that supports wireless communication such as cellular-method communication (for example, LTE-Advanced or 5G) or wireless LAN, or wired communication.

The short-range wireless communication unit 519 performs wireless communication compliant with a short-range wireless communication standard such as NFC (Near Field Communication), and exchange various items of data.

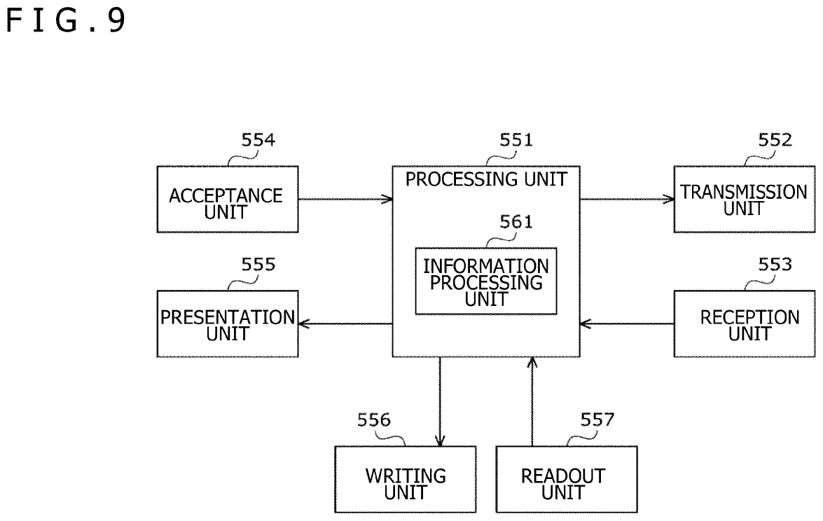

FIG. 9 illustrates an example of a functional configuration of the information device 50 in FIG. 8. In FIG. 9, each function of a processing unit 551 is realized by the CPU 511 in FIG. 8 executing various types of programs.

A transmission unit 552 and a reception unit 553 are configured as portions of the functionality held by the communication unit 518 in FIG. 8. The transmission unit 552 transmits various items of information supplied from the processing unit 551 to another device via the network 200. The reception unit 553 receives various items of information transmitted from another device via the network 200, and supplies the various items of information to the processing unit 551.

An acceptance unit 554 is configured corresponding to, for example, the operation unit 531 in FIG. 8. For example, the acceptance unit 554 uses a touch panel or a physical button to accept an instruction by an end user, and supplies operation information that corresponds to the instruction to the processing unit 551. A presentation unit 555 is configured corresponding to, for example, the display unit 541 in FIG. 8. For example, the presentation unit 555 presents presentation information supplied from the processing unit 551.

A writing unit 556 and a readout unit 557 are configured corresponding to the functionality of the short-range wireless communication unit 519 in FIG. 8. For example, the writing unit 556 uses wireless communication compliant with NFC, etc. to write various items of information supplied from the processing unit 551 to the IC chip 11 on the beverage container 10. The readout unit 557 uses wireless communication compliant with NFC, etc. to read out various items of information recorded in the IC chip 11 on the beverage container 10, and supplies the various items of information to the processing unit 551.

The processing unit 551 has an information processing unit 561. The information processing unit 561 performs processing pertaining to various items of information.

For example, in a case where beverage information transmitted from the PF server 101 is received by the reception unit 553, the information processing unit 561 presents this beverage information to the presentation unit 555 as presentation information. For example, in a case where subscription information transmitted from the PF server 101 is received by the reception unit 553, the information processing unit 561 supplies this subscription information to the writing unit 556, and has this subscription information be written to the IC chip 11 on the beverage container 10. In addition, the information processing unit 561 supplies subscription information supplied from the readout unit 557 to the transmission unit 552 and has this subscription information be transmitted to the PF server 101 via the network 200.

### (Example of Operation in Each Scenario)

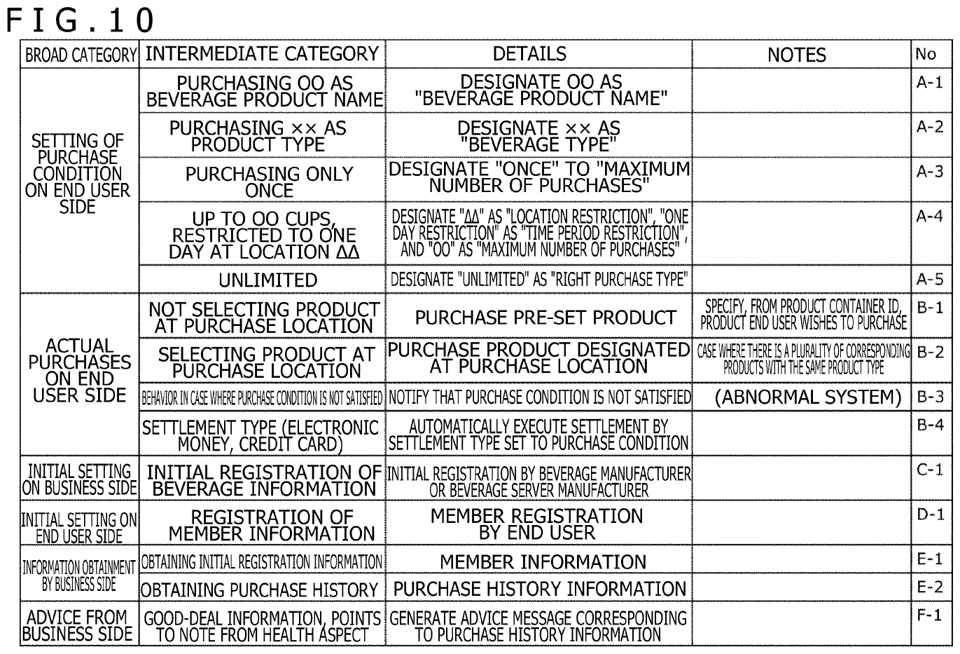

FIG. 10 illustrates an example of operation in each scenario for the beverage platform 100.

In FIG. 10, divisions are made into broad categories according to the scenarios, and into intermediate categories according to an operation in each scenario. Details of these categories and patterns of notes for these scenarios are expressed in a table.

In a scenario A which is “Setting of purchase condition on end user side,” a product to be purchased, a maximum number of purchases, a purchase location, an expiration date, and a right purchase type are each designated as a purchase condition set by an end user.

Specifically, “00” is designated as the “beverage product name” (A-1), and “xx” is designated as the “beverage type” (A-2). “Once” can be designated as the “maximum number of purchases” (A-3). Alternatively, by designating “AA” as a “location restriction”,” “one day restriction” as a “time period restriction,” and “00” as the “maximum number of purchases,” the purchase condition “up to 00 cups restricted to one day at location AA” is designated (A-4). “Unlimited” can be designated as the “right purchase type” (A-5).

In a scenario B which is “actual purchase on end user side,” when an end user actually purchases a beverage product, the end user either does not select a beverage product at the purchase location (B-1) or selects a beverage product (B-2).

Specifically, in a case where a beverage product is not selected at a purchase location, by the end user specifying a beverage product they wish to purchase from the beverage container ID on the basis of information such as a purchase condition, a beverage product that has been set in advance is purchased (B-1). In contrast, in a case where there is a plurality of beverage products corresponding to the same product type, a beverage product designated by an end user from the plurality of beverage products is purchased at the purchase location (B-2).

In addition, in the scenario B, in a case where a purchase condition is not satisfied, in other words, as behavior for an abnormal system, the end user is notified that the purchase condition is not satisfied (B-3). Furthermore, in the scenario B, settlement is automatically performed by the settlement type set in the purchase conditions (B-4).

In a scenario C which is “initial setting on business side,” as an initial registration, beverage information is registered by a beverage manufacturer or a beverage server manufacturer (C-1). In scenario D which is “initial setting on end user side,” as a member registration, member information is registered by the end user (D-1).

In a scenario E which is “information obtainment by business side,” either member information initially registered by the end user is obtained (E-1) or purchase history information pertaining to a history of actual purchases of beverage products by the end user is obtained (E-2). In a scenario F which is “advice from business side,” an advice message such as good-deal information or points to note from a health aspect is generated on the basis of purchase history information (F-1).

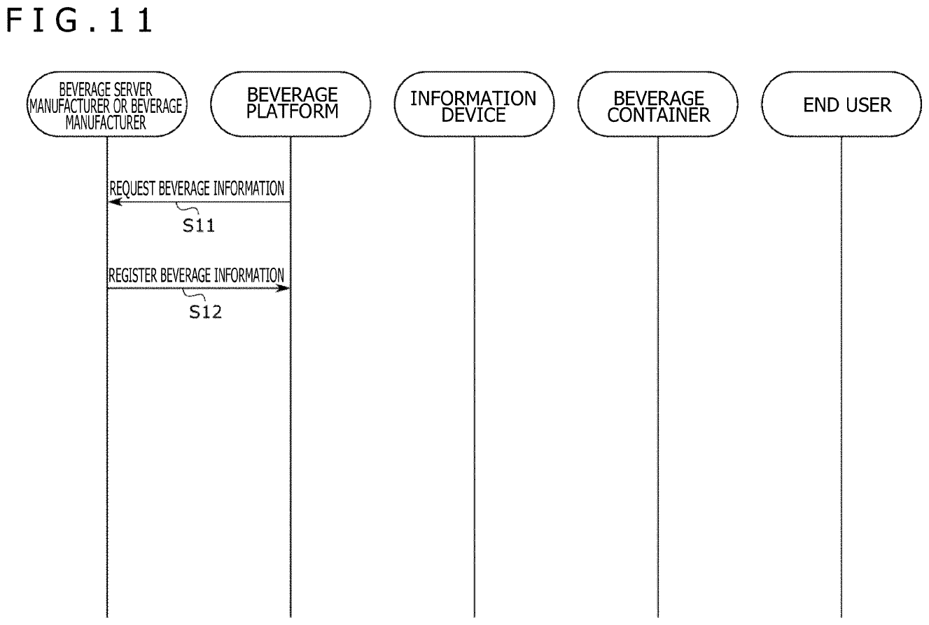

An example of a sequence for each scenario illustrated in FIG. 10 is described below with reference to FIG. 11 through FIG. 16, but description is given in the order of scenarios C, D, A, B, E, and F in alignment with an order in actual operation.

### First Example

Firstly, with reference to a sequence diagram in FIG. 11, description is given for operations in the scenario C, in other words, a flow of processing in a case of performing an initial setting on the business side.

In the sequence diagram in FIG. 11, exchanges between five objects are represented in chronological order in the vertical direction. From among these objects, “end user” represents operations by the end user U.

“Beverage container” indicates a flow of processing executed by the beverage container 10 to which the IC chip 11 is attached. “Information device” indicates a flow of processing executed by the information device 50 which is possessed by the end user U.

“Beverage platform” indicates a flow of processing executed by the PF server 101 which configures the beverage platform 100. “Beverage server manufacturer or beverage manufacturer” indicates a flow of processing executed by the manufacturer server 30. A relation between these objects is made to be similar in other drawings described below.

In a case of performing an initial setting on a business side by the beverage server manufacturer, the beverage manufacturer, etc., the PF server 101 makes a request for beverage information to the manufacturer server 30 (S11).

In response to the request from the PF server 101, the manufacturer server 30 performs an initial registration of beverage information to the beverage information DB 181 managed by the beverage information processing unit 161 in the PF server 101 which is the request source (S12). This beverage information includes information such as a purchase location, a beverage type, a beverage product name, and a settlement type.

In such a manner, the sequence diagram in FIG. 11 corresponds to C-1 in FIG. 10, and indicates a flow of processing executed in a case of performing an initial setting when using the beverage platform 100 from the business side, which is a beverage server manufacturer, a beverage manufacturer, etc.

### Second Example

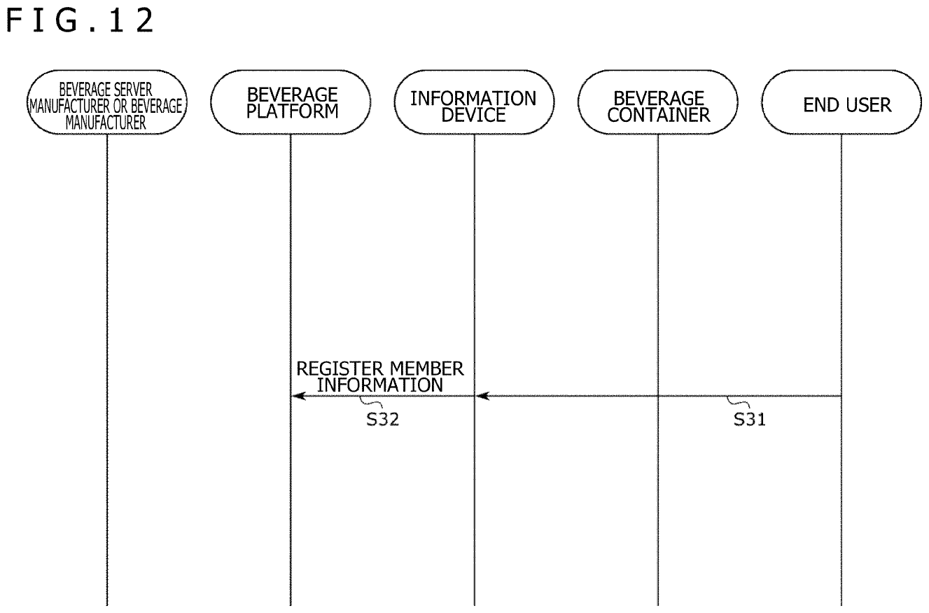

Next, with reference to a sequence diagram in FIG. 12, description is given for operations in the scenario D, in other words, a flow of processing in a case of performing an initial setting on the end user side.

In a case of performing an initial setting on the end user side, the end user U performs an operation to set member information, on a setting screen presented by the information device 50 (S31).

In response to the operation by the end user U, the information device 50 registers the member information to the member management DB 182 managed by the member information processing unit 162 in the PF server 101 (S32). This member information includes information such as a user attribute and a settlement attribute.

In such a manner, the sequence diagram in FIG. 12 corresponds to D-1 in FIG. 10 and indicates a flow of processing executed in a case of performing an initial setting when using the beverage platform 100 from the end user side.

### Third Example

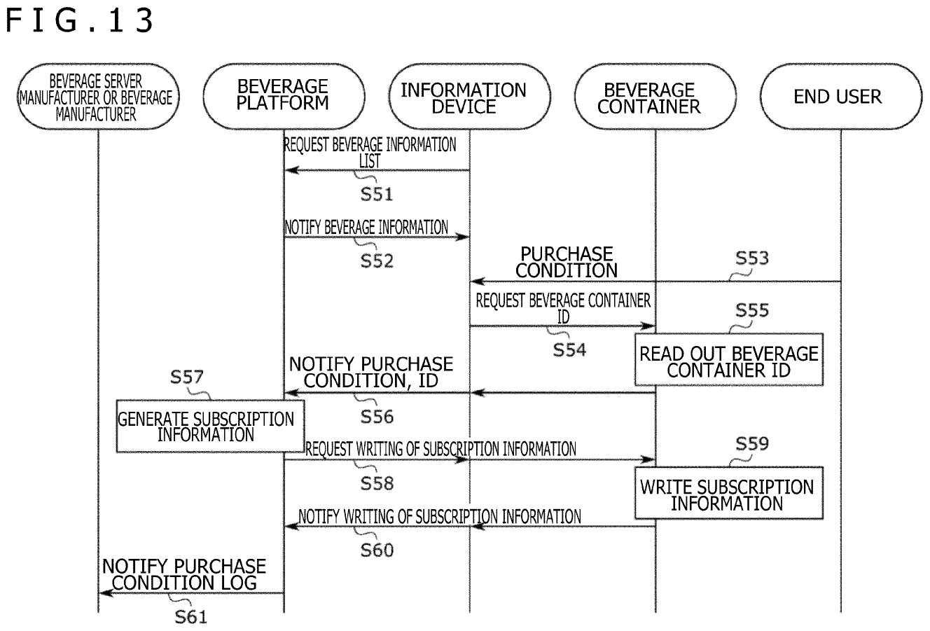

Next, with reference to a sequence diagram in FIG. 13, description is given for operations in the scenario A, in other words, a flow of processing in a case of setting a purchase condition on the end user side.

In a case of setting a purchase condition on the end user side, the information device 50 makes a request to the PF server 101 for a beverage information list (S51). Regarding a timing at which this beverage information list request is sent, the request may be automatically made by the information device 50, or the timing may be explicitly instructed by the end user U.

In response to the request from the information device 50, the beverage information processing unit 161 in the PF server 101 notifies the beverage information to the information device 50 (S52). This beverage information is the information obtained from the manufacturer server 30 and includes information such as a purchase location or a beverage type. As a result, information such as the purchase location or the beverage type is presented as presentation information by the information device 50.

The end user U performs a predetermined operation on a setting screen (presentation information) presented by the information device 50 to thereby designate a purchase condition (S53). Specifically, a beverage product name that is product a, a beverage type that is type b, a maximum number of purchases that is once, etc. are designated as purchase conditions.

In response to an operation by the end user U, the information device 50 makes a request to the IC chip 11 attached to the beverage container 10 for the beverage container ID (S54). As a result, the beverage container ID recorded in the IC chip 11 is read out by the readout unit 557 in the information device 50 (S55). The information device 50 notifies the purchase conditions and the beverage container ID to the PF server 101 (S56).

The subscription information processing unit 163 in the PF server 101 generates subscription information on the basis of the information notified from the information device 50 (S57). This subscription information includes a purchase condition and the beverage container ID.

The subscription information processing unit 163 in the PF server 101 requests the information device 50 to write the generated subscription information to the IC chip 11 on the beverage container 10 (S58). As a result, the subscription information is written to the IC chip 11 by the writing unit 556 in the information device 50 (S59), and that this writing has been performed is notified to the PF server 101 (S60).

In addition, the PF server 101 notifies the manufacturer server 30 of log information pertaining to the purchase condition designated by the end user (S61).

In such a manner, the sequence diagram in FIG. 13 corresponds to A-1 through A-4 in FIG. 10, and when setting a purchase condition on the end user side, subscription information generated on the basis of a purchase condition designated by the end user and the beverage container ID that identifies the beverage container 10 possessed by the end user is written to the IC chip 11 on the beverage container 10.

### Fourth Example

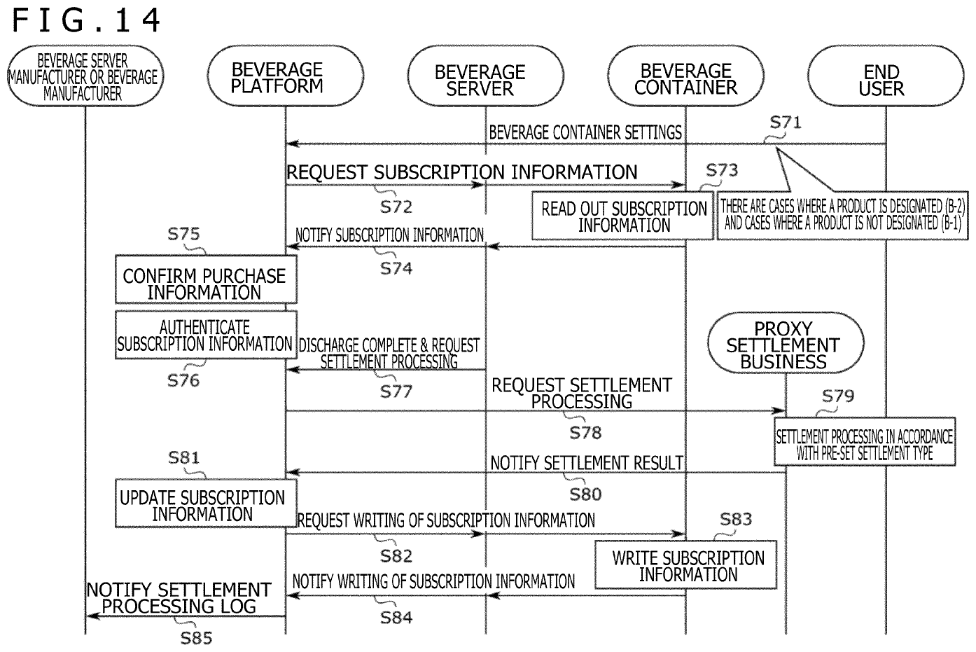

Next, with reference to a sequence diagram in FIG. 14, description is given for operations in the scenario B, in other words, a flow of processing in a case of performing an actual purchase on the end user side.

Note that, in comparison to FIG. 13, etc. described above, in the sequence diagram in FIG. 14, description is given for a “beverage server” in place of the “information device” as an object, and the “beverage server” indicates a flow of processing executed by the beverage server 20. In addition, “proxy settlement business” indicates a flow of processing executed by the proxy settlement server 40.

In a case where an actual purchase of a beverage is performed by the end user U, a setting pertaining to the beverage container 10 which has been placed on the container placement platform of the beverage server 20, and a beverage product that is a purchase target is set (S71). At this time, at the purchase location where the beverage server 20 is installed, there is a case where the end user U designates a beverage product (B-2 in FIG. 10) and a case where a beverage product is not designated (B-1 in FIG. 10).

In other words, in a case where there is a plurality of corresponding beverage products having the same product type as beverage products provided by the beverage server 20 at the purchase location, as with the former case, a beverage product designated by the end user U from among this plurality of beverage products will become a purchase target (B-2 in FIG. 10). In addition, in the latter case, a purchase target beverage product is automatically specified on the basis of information such as the purchase condition from the beverage container ID of the beverage container 10 placed on the container placement platform of the beverage server 20, on the beverage platform 100 side (B-1 in FIG. 10).

The subscription information processing unit 163 in the PF server 101 requests the beverage server 20 for the subscription information recorded to the IC chip 11 on the beverage container 10 which has been placed on the container placement platform (S72).

In the beverage server 20, the reader/writer 21 performs short-range wireless communication with the IC chip 11, whereby the subscription information is read out (S73) and notified to the PF server 101 (S74). As a result, the subscription information is obtained from the beverage server 20 by the subscription information processing unit 163 in the PF server 101.

In the subscription information processing unit 163 in the PF server 101, the purchase information (information such as the purchase condition or the number of actual purchases) which is included in the obtained subscription information is confirmed (S75), and the subscription information is authenticated (S76). For example, this authentication processing confirms whether a purchase condition such as a product to be purchased, a maximum number of purchases, a purchase location, or an expiration date which are included in the subscription information to be authenticated is satisfied, and determines whether it is possible to provide a beverage to the beverage container 10 to which is attached the IC chip 11 from which the subscription information has been read out from.

In a case of determining that it is possible to provide a beverage to the beverage container 10 placed on the container placement platform, the beverage server 20 discharges the beverage that is the purchase target to the beverage container 10. In a case where discharge of the beverage to the beverage container 10 has completed, the beverage server 20 makes a notification to this effect to the PF server 101, and also requests the PF server 101 for settlement processing (S77). Note that, in a case where a purchase condition is not satisfied, this fact (such as that an expiration date has passed) is notified to the end user U (B-3 in FIG. 10).

In response to the discharge completion notification and the settlement processing request from the beverage server 20, the settlement processing unit 164 in the PF server 101 makes a request for settlement processing to the proxy settlement server 40 (S78).

In response to request from the PF server 101, the proxy settlement server 40 performs settlement processing that corresponds to the settlement type which is set in advance (S79). The proxy settlement server 40 notifies a result of the settlement processing to the PF server 101 (S80).

In other words, the proxy settlement business acts as a proxy for settlement for the beverage subscription service, whereby the fee for the beverage that is the purchase target is paid through electronic money using functionality held by the IC chip 11, or is processed such as by a debit using a credit card associated with the beverage container ID (B-4 in FIG. 10).

The subscription information processing unit 163 in the PF server 101 updates the subscription information processing unit 163 on the basis of the discharge completion notification from the beverage server 20 and the settlement result notification from the proxy settlement server 40 (S81). For example, in response to an actual purchase of a beverage by the end user U, this update processing updates values for the number of actual purchases and the purchase datetime, from among information included in the subscription information.

The subscription information processing unit 163 in the PF server 101 requests the beverage server 20 to write the updated subscription information to the IC chip 11 (S82).

In the beverage server 20, the reader/writer 21 performs short-range wireless communication with the IC chip 11 on the beverage container 10 whereby the updated subscription information is written (S83), and notifies the PF server 101 that writing has been performed (S84).

In response to the writing notification from the beverage server 20, the PF server 101 notifies the manufacturer server 30 of log information pertaining to the settlement processing (S85).

In such a manner, the sequence diagram in FIG. 14 corresponds to B-1 through B-4 in FIG. 10, and when an actual purchase is made on the end user side, subscription information is authenticated according to a purchase condition designated by the end user or details of an actual purchase in the past. In the case where the purchase condition is satisfied, settlement processing is performed after discharge of the beverage to the beverage container 10 has completed, and the subscription information, which is updated according to details of the present actual purchase, is written to the IC chip 11 on the beverage container 10.

Note that the timing of the settlement processing can be changed according to service details of the beverage subscription service, contract details for the end user U, etc. For example, as illustrated in FIG. 14, it may be that settlement processing is performed when the end user U has actually purchased a beverage, or, in the case of service details or contract details in which service for a certain time period (such as one month or one year) is received for a fixed fee, it may be that settlement processing to pay the fixed fee is performed at an optional timing (a timing such as a fixed payment each month or payment once per year).

### Fifth Example

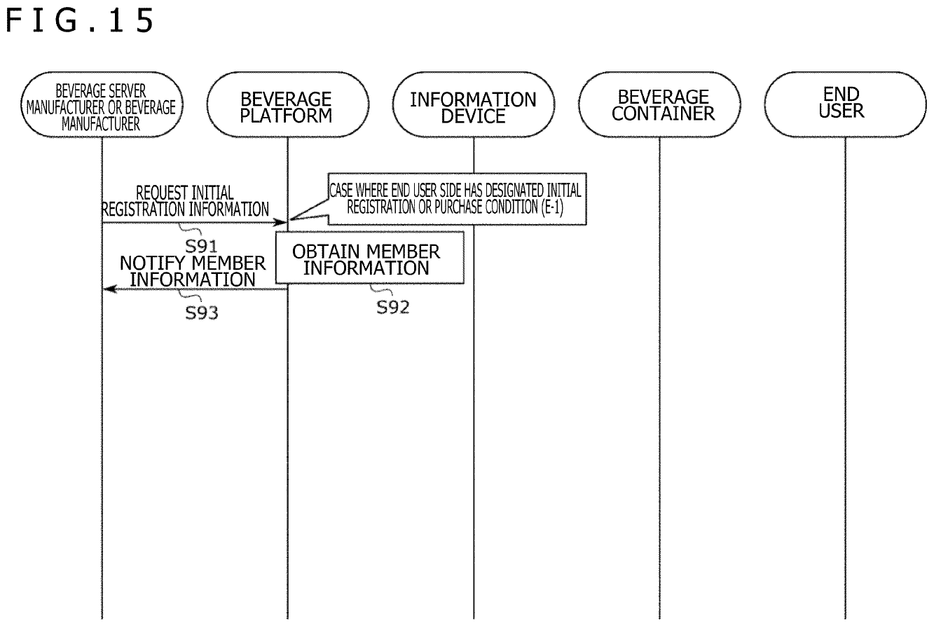

Next, with reference to a sequence diagram in FIG. 15, description is given for operations in the scenario E, in other words, a flow of processing in a case of obtaining information regarding the business side.

In a case of obtaining initial registration information regarding the business side by the beverage server manufacturer, the beverage manufacturer, etc., the manufacturer server 30 makes a request for initial registration information to the PF server 101 (S91).

In response to the request from the manufacturer server 30, the member information processing unit 162 in the PF server 101 obtains member information (S92). Here, member information managed by the member management DB 182 is obtained as the initial registration information, and is notified to the manufacturer server 30 which is the request source (S93). This member information includes information such as a user ID or a user attribute.

Note that, at a time of obtainment of initial registration information by the business side, it is necessary to set in advance a purchase condition or initial registration information regarding the end user side, in the operations in scenarios A and D.

In such a manner, the sequence diagram in FIG. 15 corresponds to E-1 in FIG. 10 and indicates a flow of processing executed in a case where obtainment of various items of information is performed from the business side such as a beverage server manufacturer or a beverage manufacturer, when the beverage platform 100 is used.

### Sixth Example

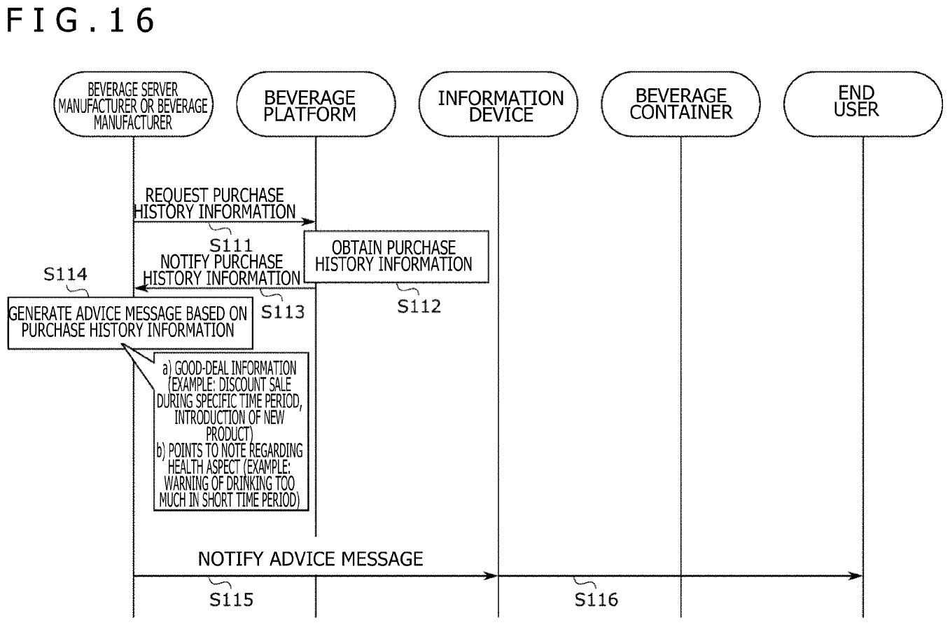

Finally, with reference to a sequence diagram in FIG. 16, description is given for operations in the scenarios E and F, in other words, a flow of processing in a case of obtaining information and performing advice on the business side.

In a case of obtaining purchase history information regarding the business side by the beverage server manufacturer, the beverage manufacturer, etc., the manufacturer server 30 makes a request for purchase history information to the PF server 101 (S111).

In response to the request from the manufacturer server 30, the member information processing unit 162 in the PF server 101 obtains the purchase history information (S112). Here, the purchase history information being managed by the member management DB 182 is obtained and notified to the manufacturer server 30 which is the request source (S113).

The manufacturer server 30 generates an advice message on the basis of the purchase history information from the PF server 101 (S114). Here, by analyzing a purchase history of beverages by the end user U, a message pertaining to good-deal information such as a discount sale in a specific time period or the introduction of a new product is generated, or a message pertaining to points to note on a health aspect such as a warning on drinking too much of a specific beverage in a short period of time is generated.

The manufacturer server 30 notifies the generated advice message to the information device 50 possessed by the end user U (S115). As a result, the end user U can confirm the advice message which is presented by the information device 50, and obtain information such as the good-deal information that corresponds to their own purchase of a beverage, or points to note on a health aspect (S116).

In such a manner, the sequence diagram in FIG. 16 corresponds to E-2 and F-1 in FIG. 10 and indicates a flow of processing executed in a case where notification of an advice message to the end user U is made from the business side such as a beverage server manufacturer or a beverage manufacturer, when the beverage platform 100 is used.

### 2. Variations

In the description given above, an example has been given for a configuration in which the reader/writer 21 in the beverage server 20 or the short-range wireless communication unit 519 in the information device 50 performs short-range wireless communication with the IC chip 11 attached to the beverage container 10 to thereby write or read out subscription information, but there is no limitation to short-range wireless communication such as NFC (for example, FeliCa (registered trademark)), and another communication method may be used. Alternatively, it may be that a code such as a two-dimensional code (for example, a QR code (registered trademark)) or a barcode is used to present subscription information, and reading is performed by capturing with a camera, etc.

In addition, in the description given above, an example has been given for a configuration in which the information device 50 which is a smartphone, etc. performs short-range wireless communication such as NFC with the IC chip 11 on the beverage container 10 to read and write subscription information, but it may be that an external device such as a dedicated reader/writer is used to read and write subscription information in the IC chip 11. In addition, when an end user operates the information device 50 which is a smartphone, etc. to input information such as member information or a purchase condition, the end user can input information by performing a tap operation on a touch panel or input information using a voice input.

In addition, in the description given above, an example has been given for a configuration in which the beverage platform 100 is used to provide a beverage subscription service, but, using a platform to which the present technology has been applied, there is no limitation to a service pertaining to beverages, and it may be that another service such as a service for providing another article, various types of rental services, or a sharing service is provided.

By virtue of the present technology as above, using an information processing apparatus (for example, the PF server 101 which configures the beverage platform 100), purchase information (for example, subscription information) which includes a purchase condition pertaining to purchase of a beverage and a container identifier (for example, a beverage container ID) identifying a beverage container (for example, a beverage container 10 which is a reusable cup, etc.) is generated, and processing (for example, processing in the sequence diagram in FIG. 14) for providing a beverage using the beverage container is performed on the basis of the generated purchase information.

In addition, when an end user purchases a beverage they like using a beverage container 10 which is a reusable cup, a reusable bottle, etc., the end user can purchase the beverage without designating the beverage each time and also without explicitly designating settlement means. In addition, because it is possible to limit a purchase location, provide an expiration date, or set a maximum number of purchases that corresponds to a product scheduled to be purchased, it is possible to propose subscription-based usage that considers ease for end users or requests by end users. As a result, it is possible to more simply provide a beverage using a beverage container 10 which is a reusable cup, etc.

Furthermore, an end user can always use a beverage container 10 such as their favorite reusable cup to receive provision of a beverage on-the-go, and thus can easily enjoy a beverage on-the-go. In addition, because history management pertaining to beverages, such as what, when, and how much an end user drank, it is possible to perform management such as beverage history management for which a target amount to drink in one day is decided, or providing, for example, a daily upper limit for alcoholic beverages to thereby limit from the beverage server 20 a number of times that drinking is possible.

Using such history management, it is possible to define a healthcare guide for an end user or provide advice using a purchase history. For example, it is possible to manage purchase history for an end user as log information, and, using this log information, for a beverage manufacturer or a beverage server manufacturer to present advice on a health aspect (healthcare) to the end user.

In relation to payment of a fee for a purchased beverage, by using the IC chip 11 attached to a beverage container 10 which is a reusable cup, etc., payment using various types of electronic money or a debit using a credit card associated with a beverage container ID become possible. Accordingly, an end user can pay the fee for a purchased beverage without expending time and effort.

At present, PET bottles or cans are the primary containers used when a beverage is purchased at a vending machine, etc. and it is difficult to say that efforts to reduce the load on the global environment have been sufficiently performed. However, by an end user using a beverage container 10 which is a reusable cup, etc., the frequency of use of PET bottles or cans is reduced, and it possible to reduce plastic or aluminum rubbish. As a result, it is possible to realize sufficient efforts to handle a reduction of the load on the global environment.

In addition, for a beverage manufacturer, in addition to a business premised on existing containers such as PET bottles, cans, or bottles, it is possible to establish a business form that enables one-to-one marketing based on purchase history, where end users are directly connected to via the beverage server 20 and a beverage container 10, which is a reusable cup, etc. One-to-one marketing is a method in which, when a company carries out marketing activities, customers are individually marketed on the basis of each customer's preferences, attributes, etc.

### 3. Computer Configuration

Processing for each step in the flow charts described above can be executed by hardware or can be executed by software. In a case of executing a series of processing by software, a program that configures this software is installed to a computer for each apparatus.

A program executed by a computer can be, for example, provided by being recorded onto a removable recording medium, which corresponds to a package media, etc. In addition, a program can be provided via a wired or wireless transmission medium such as a local area network, the internet, or digital satellite broadcasting.

In a computer, a program can be installed to a storage unit via an input/output I/F, by mounting a removable recording medium to a drive. In addition, a program can be received by a communication unit via a wired or wireless transmission medium and installed to the storage unit. In addition, a program can be installed in advance in a ROM or the storage unit.

Here, in the present specification, processing that a computer performs according to a program does not necessarily need to be performed in chronological order following an order described as a flow chart. In other words, processing that a computer performs according to a program includes processing executed in parallel or executed individually (for example, parallel processing or processing according to an object).

In addition, a program may be processed by one computer (processor) or may be subjected to distributed processing by a plurality of computers. Furthermore, a program may be executed after being transferred to a remote computer.

Furthermore, in the present specification, a system means a set of a plurality of components (such as apparatuses or modules (components)), and it does not matter whether or not all components are inside the same case. Accordingly, a plurality of apparatuses which are accommodated in separate cases and are connected via a network, and one apparatus in which a plurality of modules is accommodated in one case are both systems.

Note that an embodiment of the present technology is not limited to embodiments described above, and various modifications are possible within a scope that does not deviate from the substance of the present technology. For example, the present technology can have a cloud computing configuration in which one function is apportioned among a plurality of apparatuses via a network, and processing is jointly performed.

In addition, each step described above in the flow charts described above, in addition to being executed by one apparatus, can be executed by being apportioned among a plurality of apparatuses. Furthermore, in a case where a plurality of processing is included in one step, the plurality of processing included in the one step, in addition to being executed by one apparatus, can be executed by being apportioned among a plurality of apparatuses.

In addition, effects described in the present specification are purely exemplary and are not limiting, and there may be other effects.

Note that the present technology can have configurations such as the following.

(1)

An information processing apparatus including:

a processing unit that
generates purchase information that includes a purchase condition pertaining to a purchase of a beverage and a container identifier that identifies a beverage container, and
on the basis of the generated purchase information, performs processing for providing the beverage using the beverage container.

(2)

The information processing apparatus according to (1), in which

the processing unit
records the purchase information to the beverage container, and
when the purchase of a beverage using the beverage container is performed by an end user, processes the recorded purchase information according to details of the purchase of the beverage.

(3)

The information processing apparatus according to (2), in which

the purchase condition includes at least one item of information from among a purchase location, an expiration date, a product to be purchased, a maximum number of purchases, and a settlement type.

(4)

The information processing apparatus according to any one of (1) to (3), in which

the purchase condition is designated by the end user.

(5)

The information processing apparatus according to any one of (1) to (4), in which

the container identifier is recorded to the beverage container.

(6)

The information processing apparatus according to (5), in which

the processing unit
in response to a request from a device belonging to the end user, notifies presentation information pertaining to a beverage, and
generates the purchase information on the basis of the purchase condition designated by the end user in response to the presentation information that is presented, and the container identifier obtained from the beverage container.

(7)

The information processing apparatus according to (6), in which

the processing unit notifies the presentation information on the basis of beverage information pertaining to a beverage that is provided by a device belonging to a beverage manufacturer or a beverage server manufacturer.

(8)

The information processing apparatus according to any one of (1) to (7), in which

the processing unit processes the purchase information after setting, as a purchase target beverage, a beverage designated by the end user at a purchase location or a beverage specified from the container identifier.

(9)

The information processing apparatus according to (8), in which

the processing unit
in response to provision of the purchase target beverage to the beverage container, performs processing pertaining to settlement for the purchase target beverage, and
on the basis of a processing result for the purchase information, updates the purchase information recorded to the beverage container.

(10)

The information processing apparatus according to (9), in which

the processing unit
makes a request for settlement for the purchase target beverage to a proxy settlement server that performs processing pertaining to settlement that corresponds to a settlement type, and
obtains a processing result that pertains to settlement and is notified from the proxy settlement server.

(11)

The information processing apparatus according to (9) or (10), in which

the processing unit
accumulates, as history information, a history pertaining to a purchased beverage, and
in response to a request from a device belonging to a beverage manufacturer or a beverage server manufacturer, notifies the accumulated history information.

(12)

The information processing apparatus according to (11), in which

a message to the end user is generated on the basis of the history information, and

the generated message is presented to the end user by a device belonging to the end user.

(13)

The information processing apparatus according to any one of (1) to (12), in which

the purchase information is recorded to an IC chip that includes a short-range wireless communication function and is attached to a predetermined position on the beverage container, and

the processing unit uses short-range wireless communication to have the processed purchase information be written to the IC chip, or processes the purchase information read out from the IC chip.

(14)

The information processing apparatus according to (13), in which

a beverage server that discharges a beverage to the beverage container has a reader/writer that includes a short-range wireless communication function, and the processing unit uses the reader/writer to write the processed purchase information to the IC chip or process the purchase information read out from the IC chip.

(15)

The information processing apparatus according to any one of (1) to (14), in which

the beverage container includes a reusable cup or a reusable bottle used by each end user, and

the purchase information is individual information for each end user and includes subscription information corresponding to a subscription method.

(16)

The information processing apparatus according to (15), in which

the purchase information further includes the number of actual purchases and a purchase datetime.

(17)

An information processing method including:

by an information processing apparatus

generating purchase information that includes a purchase condition pertaining to a purchase of a beverage and a container identifier that identifies a beverage container, and

on the basis of the generated purchase information, performing processing for providing the beverage using the beverage container.

(18)

A beverage container including:

an IC chip that, in response to a request from an information processing apparatus that generates purchase information including a purchase condition pertaining to purchase of a beverage and a container identifier identifying a beverage container, and, on the basis of the generated purchase information, performs processing for providing the beverage using the beverage container, performs short-range wireless communication with a reader/writer provided in a beverage server that discharges the beverage to the beverage container, whereby the purchase information is written or the purchase information, having been recorded, is read out.

(19)

A beverage server including:

a reader/writer that, in response to a request from an information processing apparatus that generates purchase information including a purchase condition pertaining to purchase of a beverage and a container identifier identifying a beverage container, and, on the basis of the generated purchase information, performs processing for providing the beverage using the beverage container, performs short-range wireless communication with an IC chip attached to the beverage container placed on a container placement platform, whereby the purchase information is written or the purchase information, having been recorded, is read out.

(20)

An electronic device including:

a presentation unit that presents presentation information pertaining to a beverage, the presentation information being notified from an information processing apparatus that generates purchase information including a purchase condition pertaining to purchase of the beverage and a container identifier identifying a beverage container, and, on the basis of the generated purchase information, performs processing for providing the beverage using the beverage container;

an acceptance unit that accepts the purchase condition designated by an end user in response to the presented presentation information; and

a readout unit that reads out the container identifier that has been recorded to the beverage container, in which

the purchase information is generated on the basis of the purchase condition designated by the end user and the container identifier read out from the beverage container.

### REFERENCE SIGNS LIST

10: Beverage container
10-1: Reusable cup
10-2: Reusable bottle
11: IC chip
20, 20-1 through 20-N: Beverage server
21: Reader/writer
30: Manufacturer server
40: Proxy settlement server
50: Information device
100: Beverage platform
101: PF server
111: CPU
112: ROM
113: RAM
116: Input unit
117: Output unit
118: Storage unit
119: Communication unit
151: Processing unit
152: Transmission unit
153: Reception unit
154: Database
161: Beverage information processing unit
162: Member information processing unit
163: Subscription information processing unit
164: Settlement processing unit
200: Network
511: CPU
512: ROM
513: RAM
515: Input unit
516: Output unit
517: Storage unit
518: Communication unit
519: Short-range wireless communication unit
531: Operation unit
532: Camera unit
533: Sensor unit
541: Display unit
542: Sound output unit
551: Processing unit
552: Transmission unit
553: Reception unit
554: Acceptance unit
555: Presentation unit
556: Writing unit
557: Readout unit
561: Information processing unit

1. An information processing apparatus comprising:
a processing unit that
generates purchase information that includes a purchase condition pertaining to a purchase of a beverage and a container identifier that identifies a beverage container, and
on a basis of the generated purchase information, performs processing for providing the beverage using the beverage container.

2. The information processing apparatus according to claim 1, wherein
the processing unit
records the purchase information to the beverage container, and
when the purchase of a beverage using the beverage container is performed by an end user, processes the recorded purchase information according to details of the purchase of the beverage.

3. The information processing apparatus according to claim 2, wherein
the purchase condition includes at least one item of information from among a purchase location, an expiration date, a product to be purchased, a maximum number of purchases, and a settlement type.

4. The information processing apparatus according to claim 3, wherein
the purchase condition is designated by the end user.

5. The information processing apparatus according to claim 4, wherein
the container identifier is recorded to the beverage container.

6. The information processing apparatus according to claim 5, wherein
the processing unit
in response to a request from a device belonging to the end user, notifies presentation information pertaining to a beverage, and
generates the purchase information on a basis of the purchase condition designated by the end user in response to the presentation information that is presented, and the container identifier obtained from the beverage container.

7. The information processing apparatus according to claim 6, wherein
the processing unit notifies the presentation information on a basis of beverage information pertaining to a beverage that is provided by a device belonging to a beverage manufacturer or a beverage server manufacturer.

8. The information processing apparatus according to claim 3, wherein
the processing unit processes the purchase information after setting, as a purchase target beverage, a beverage designated by the end user at a purchase location or a beverage specified from the container identifier.

9. The information processing apparatus according to claim 8, wherein
the processing unit
in response to provision of the purchase target beverage to the beverage container, performs processing pertaining to settlement for the purchase target beverage, and
on a basis of a processing result for the purchase information, updates the purchase information recorded to the beverage container.

10. The information processing apparatus according to claim 9, wherein
the processing unit
makes a request for settlement for the purchase target beverage to a proxy settlement server that performs processing pertaining to settlement that corresponds to a settlement type, and
obtains a processing result that pertains to settlement and is notified from the proxy settlement server.

11. The information processing apparatus according to claim 9, wherein
the processing unit
accumulates, as history information, a history pertaining to a purchased beverage, and
in response to a request from a device belonging to a beverage manufacturer or a beverage server manufacturer, notifies the accumulated history information.

12. The information processing apparatus according to claim 11, wherein
a message to the end user is generated on a basis of the history information, and
the generated message is presented to the end user by a device belonging to the end user.

13. The information processing apparatus according to claim 1, wherein
the purchase information is recorded to an IC chip that includes a short-range wireless communication function and is attached to a predetermined position on the beverage container, and
the processing unit uses short-range wireless communication to have the processed purchase information be written to the IC chip, or processes the purchase information read out from the IC chip.

14. The information processing apparatus according to claim 13, wherein
a beverage server that discharges a beverage to the beverage container has a reader/writer that includes a short-range wireless communication function, and
the processing unit uses the reader/writer to write the processed purchase information to the IC chip or process the purchase information read out from the IC chip.

15. The information processing apparatus according to claim 1, wherein
the beverage container includes a reusable cup or a reusable bottle used by each end user, and
the purchase information is individual information for each end user and includes subscription information corresponding to a subscription method.

16. The information processing apparatus according to claim 15, wherein
the purchase information further includes the number of actual purchases and a purchase datetime.

17. An information processing method comprising:
by an information processing apparatus
generating purchase information that includes a condition pertaining to a purchase of a beverage and an identifier that identifies a beverage container, and
on a basis of the generated purchase information, performing processing for providing the beverage using the beverage container.

18. A beverage container comprising:
an IC chip that, in response to a request from an information processing apparatus that generates purchase information including a purchase condition pertaining to purchase of a beverage and a container identifier identifying a beverage container, and, on a basis of the generated purchase information, performs processing for providing the beverage using the beverage container, performs short-range wireless communication with a reader/writer provided in a beverage server that discharges the beverage to the beverage container, whereby the purchase information is written or the purchase information, having been recorded, is read out.

19. A beverage server comprising:
a reader/writer that, in response to a request from an information processing apparatus that generates purchase information including a purchase condition pertaining to purchase of a beverage and a container identifier identifying a beverage container, and, on a basis of the generated purchase information, performs processing for providing the beverage using the beverage container, performs short-range wireless communication with an IC chip attached to the beverage container placed on a container placement platform, whereby the purchase information is written or the purchase information, having been recorded, is read out.

20. An electronic device comprising:
a presentation unit that presents presentation information pertaining to a beverage, the presentation information being notified from an information processing apparatus that generates purchase information including a purchase condition pertaining to purchase of the beverage and a container identifier identifying a beverage container, and, on a basis of the generated purchase information, performs processing for providing the beverage using the beverage container;
an acceptance unit that accepts the purchase condition designated by an end user in response to the presented presentation information; and
a readout unit that reads out the container identifier that has been recorded to the beverage container, wherein
the purchase information is generated on a basis of the purchase condition designated by the end user and the container identifier read out from the beverage container.
